(19) United States
(12) Patent Application Publication
(10) Pub. No.: US 2015/0083964 A1
(43) Pub. Date: Mar. 26, 2015

(54) METHOD AND DEVICE FOR EXTRACTING HIGHLY VOLATILE DEGRADATION PRODUCTS FROM THE ABSORBENT LOOP OF A CO2 SEPARATION PROCESS

(71) Applicants: Björn Fischer, Frankfurt a.M. (DE); Erwin Johannes Martinus Giling, Delft (NL); Earl Lawrence Vincent Goetheer, Mol (BE); Ralph Joh, Seligenstadt (DE); Markus Kinzl, Dietzenbach (DE); Diego Andres Kuettel, Wiesbaden (DE); Rüdiger Schneider, Eppstein (DE); Jan Harm Urbanus, Loenen aan de Vecht (NL)

(72) Inventors: Björn Fischer, Frankfurt a.M. (DE); Erwin Johannes Martinus Giling, Delft (NL); Earl Lawrence Vincent Goetheer, Mol (BE); Ralph Joh, Seligenstadt (DE); Markus Kinzl, Dietzenbach (DE); Diego Andres Kuettel, Wiesbaden (DE); Rüdiger Schneider, Eppstein (DE); Jan Harm Urbanus, Loenen aan de Vecht (NL)

(73) Assignee: SIEMENS AKTIENGESELLSCHAFT, Munich (DE)

(21) Appl. No.: 14/236,469

(22) PCT Filed: Aug. 1, 2012
(86) PCT No.: PCT/EP2012/065029

§ 371 Date: Mar. 7, 2014

(30) Foreign Application Priority Data
Aug. 18, 2011 (EP) 11177910.4

(51) Int. Cl. B01D 53/96

(52) U.S. Cl. CPC B01D 53/96; B01D 2257/504; B01D 2251/70; B01D 2251/80; B01D 2251/606
USPC 252/189

(57) ABSTRACT

Apparatus and process for removal of volatile degradation products from the absorbent circuit of a CO2 separation process are provided. The CO2 separation process may use the absorbent circuit in an absorption process and a desorption process. Condensate is withdrawn from a condensation process connected downstream of the desorption process, and purified to substantially free such condensate of degradation products. The purified condensate is recycled back to the absorbent circuit.

### CROSS REFERENCE TO RELATED APPLICATIONS

This application is the US National Stage of International Application No. PCT/EP2012/065029 filed Aug. 1, 2012, and claims the benefit thereof. The International Application claims the benefit of European Application No. EP11177910 filed Aug. 18, 2011. All of the applications are incorporated by reference herein in their entirety.

### FIELD OF INVENTION

Process and apparatus for removal of volatile degradation products from the absorption circuit of a CO2 separation process.

### BACKGROUND OF INVENTION

In fossil-fired power plants for generation of electrical power, the combustion of a fossil fuel gives rise to a carbon dioxide-containing flue gas. To avoid or to reduce carbon dioxide emissions, carbon dioxide has to be removed from the flue gases. Various methods for removal of carbon dioxide from a gas mixture are common knowledge. The method of absorption-desorption is commonly used especially for removal of carbon dioxide from a flue gas after a combustion process. On the industrial scale, this involves scrubbing carbon dioxide out of the flue gas with an absorbent (CO2 separation process). Such a CO2 capture process comprises essentially an absorber in which CO2 is scrubbed out of the flue gas with an absorption solution, and a desorber in which CO2 is driven back out of the absorption solution.

Commonly used absorption solutions, for example methanolamine (MEA), amino acid salts or potash, exhibit a good selectivity and a high capacity for CO2.

As a result of the trace elements present in the flue gas, for example SOx and NOx, but also particularly as a result of oxygen, all absorption solutions have a tendency to degradation. This forms various degradation products, which are volatile particularly in the case of use of absorbents such as alkanolamines or cyclic amines, and can leave the absorber together with the cleaned flue gas. The resulting emissions should be reduced as far as possible.

A first approach to the reduction of harmful emissions is the use of salts, for example amino acid salts. Aqueous absorption solutions containing amino acid salts have the advantage that they do not themselves have any vapor pressure, and discharge from the absorber can be avoided as a result. The degradation products of absorption solutions containing amino acid salts, as a result of degradation, are for the most part again salt-type components and therefore likewise do not have any significant vapor pressure. A small portion of the degradation products, however, could also include volatile components, for example ammonia.

The degradation products concentrate in the absorbent circuit with time. Particularly at high temperatures, due to the equilibrium, they tend to be transferred to the gas phase. Due to the large amounts of flue gas, and the concentration over time, there is inevitably discharge of these components into the atmosphere. To date, attempts to reduce these emissions have involved a downstream scrubbing at the top of the absorber. This requires a larger absorber column and high capital costs, and causes further contamination of the wastewater stream and/or absorbent stream.

### SUMMARY OF INVENTION

Aspects of the invention are directed to a process by which degradation products can be substantially eliminated in a simple manner with minimum energy expenditure from an absorbent circuit of a CO2 separation process, without impairment of or damage to the absorption solution. Further aspects of the invention are directed to an apparatus in which the process according to the invention can be executed.

For removal of volatile degradation products from the absorbent circuit of a CO2 separation process, the absorbent circuit comprising an absorption process and a desorption process, condensate is withdrawn from a condensation process connected downstream of the desorption process, purified to substantially free it of degradation products, and recycled back to the absorbent circuit.

Conceptual aspects of the invention proceed from the finding that the concentration of the degradation products is at its greatest in the gas phase of the desorber, since the degradation is promoted by high temperatures and the equilibrium is shifted toward the gas phase. The degradation products are liquefied again in the condenser connected downstream of the desorber, and are thus present dissolved in the condensate water.

The condensate stream is merely a small substream of the overall absorbent circulation. Since only this small substream of the absorbent circulation need be purified, the purifying apparatus can be configured to be much smaller than a purifying apparatus which has to accept the entire absorbent circulation. The purification is also much more effective, since the degradation products are particularly concentrated in the condensate. The condensate stream is also much smaller and more highly concentrated in degradation products than the gaseous off gas stream at the top of the absorber. Therefore, the treatment of the condensate stream is also advantageous over a scrubbing connected downstream of the absorber. Moreover, the condenser is present as standard and therefore need not be installed specially. The condenser is connected downstream of the desorber.

The purification of the condensate can particularly advantageously be undertaken by distillation. Distillation is particularly suitable as a purification process since the result is a high-purity condensate. In addition, the thermal energy required for the distillation can be provided by the CO2 separation process without any problem. Here too, it is advantageous that only the condensate need be purified as a substream, and not all of the absorbent of the absorbent circuit.

In an alternative embodiment, which can also be effected in parallel, upstream or downstream of the distillative purification, the purification of the condensate to free it of degradation products is performed by means of an activated carbon wash. Such activated carbon filters are inexpensive and do not require any additional energy. The activated carbon filters can also achieve a high-purity condensate.

In a further advantageous configuration of the process, the absorbent conducted within the absorbent circuit is an aqueous solution of an amine, of an amino acid, or of potash. The absorbent is preferably an aqueous solution of a primary or secondary amino acid salt. Amino acid salts do not have any noticeable vapor pressure, as a result of which virtually no amino acid salt is discharged into the atmosphere via the absorption process. The degradation products of the amino acid salts are likewise again salts which do not have any noticeable vapor pressure.

Overall, the use of amino acid salt in conjunction with the inventive purification of the degradation products provides a CO2 separation process through which it is possible not to discharge any significant amounts of scrubbing-active substances, or degradation products thereof, into the atmosphere. As a result of the continuous purification and separation of the degradation products out of the absorbent, the degradation products can no longer settle out, or can do so only to a minor degree, on the trays or the packings of the columns. This enables longer operation of the CO2 separation apparatus without maintenance or exchange of the absorbent.

Aspects of the invention directed to an apparatus allow for removal of volatile degradation products from an absorbent of a CO2 separation apparatus comprising an absorber and a desorber connected within an absorbent circuit, condensate can be supplied via a condensate removal line of a purifying apparatus to the condenser connected downstream of the desorber, and a condensate purified to free it of degradation products in the purifying apparatus can be recycled via a condensate recycle line back to the absorbent circuit.

In an advantageous configuration of the apparatus, the purifying apparatus is a distillation plant by which the degradation products can be removed by distillation from the condensate. In an alternative or additional embodiment of the apparatus, the purifying apparatus comprises an activated carbon filter by which the degradation products from the condensate are retained.

### BRIEF DESCRIPTION OF THE DRAWINGS

Working examples of the invention are explained in detail hereinafter with reference to figures. The figures show:

FIG. 1 a process circuit diagram of a process for purifying an absorbent contaminated with degradation products,

FIG. 2 a CO2 separation apparatus with a conventional purifying apparatus,

FIG. 3 a CO2 separation apparatus with a purifying apparatus in the condensate stream.

### DETAILED DESCRIPTION OF INVENTION

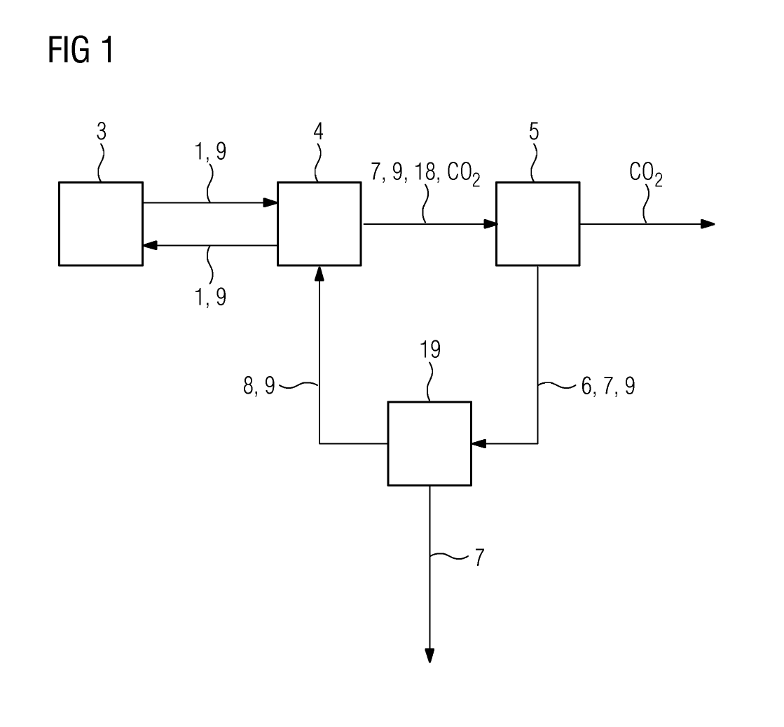

FIG. 1 shows a process circuit diagram of a process for purifying an absorbent 9 contaminated with degradation products 7. What are shown are an absorption process 3 and a desorption process 4 connected within an absorbent circuit 1. A vapor 18 comprising gaseous CO2, gaseous degradation products 7 and vaporous absorbent 9 leaves the desorption process 4. The vapor 18 is sent to a condensation process 5 in which the vapor 18 is cooled, such that the vaporous absorbent condenses, and forms a condensate 6. The degradation products 7 are bound again in the condensate 6. The condensation process 5 thus separates gaseous CO2 and condensed absorbent 9 from one another. A gaseous CO2 and a condensate 6 with a high concentration of volatile degradation products 7 leave the condensation process 5.

The condensate 6 is then sent to a purification process 19 in which the degradation products 7 are filtered out or removed. The filtering-out can be accomplished by means of activated carbon filters. In addition or alternatively, the degradation products can also be removed by distillation. The energy for the distillation process which is not specified in detail here can be taken from the power plant process. The degradation products 7 are drawn off from the purification process 19 and discharged. The removal of the degradation products 7 from the condensate 6 forms a purified condensate 8 which is recycled back to the desorption process 4.

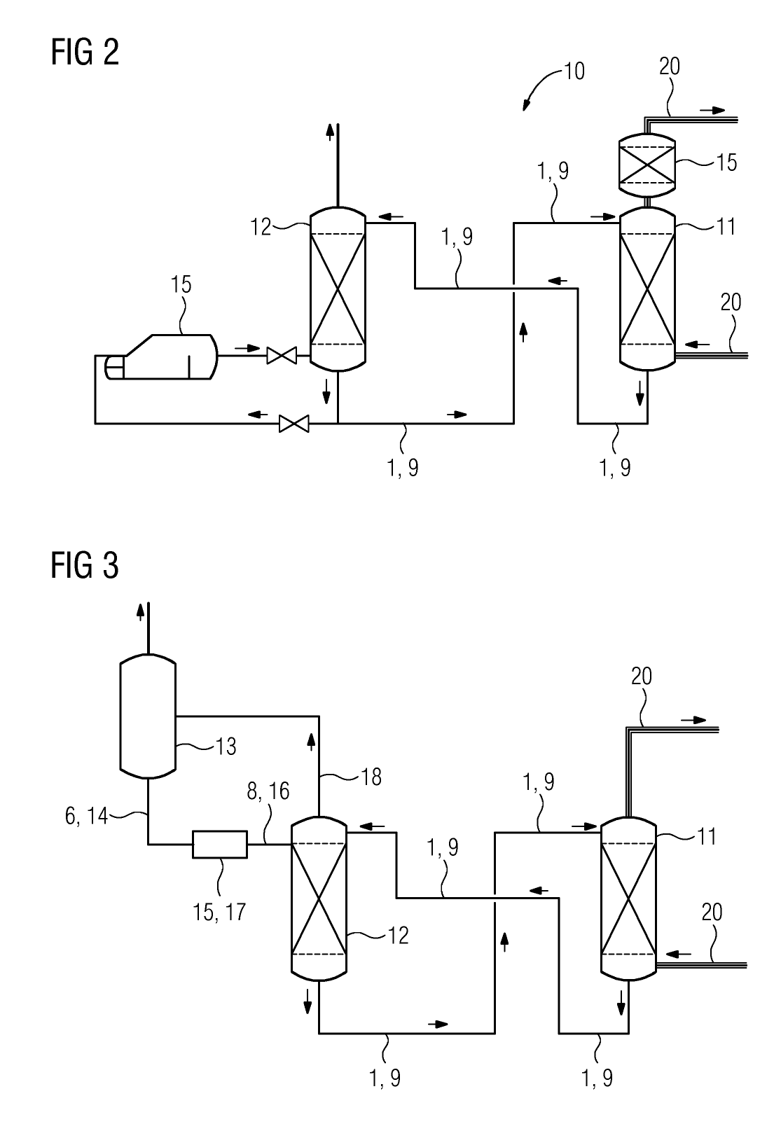

FIG. 2 shows a CO2 separation apparatus 10 with a conventional purifying apparatus 15. The CO2 separation apparatus 10 comprises essentially an absorber 11 and a desorber 12 connected to one another via an absorbent circuit 1. An absorbent 9 is conducted within the absorbent circuit 1. The absorber 11 is connected within a flue gas duct 20 of a fossil-fired power plant.

For removal of volatile degradation products 7 from the flue gas stream which leaves the absorber 11 at the top, it is known that a purifying apparatus 15 can be connected downstream of the absorber 11 in the flow into the flue gas duct 20. This purifying apparatus 15 can remove a majority of the degradation products 7 from the flue gas. However, the dimensions of this downstream purifying apparatus should be of appropriate size according to the flue gas stream, and it is quite energy-intensive.

An alternative known purifying apparatus 15 for removal of degradation products 7 is shown in FIG. 2 as a purifying apparatus 15 connected downstream of the desorber 12. This purifying apparatus 15 is connected within the absorbent circuit of the CO2 separation apparatus. It is thus possible to filter the degradation products 7 out of the absorbent 9 or to process the absorbent 9. Since, however, all of the absorbent stream must always be treated, this type of purifying apparatus 15 should likewise be designed to be correspondingly large, and as a result is also correspondingly energy-intensive in operation.

FIG. 3 shows a CO2 separation apparatus with an inventive purifying apparatus 15 in the condensate stream. The CO2 separation apparatus 10 shown in FIG. 3 comprises essentially, likewise as already detailed for FIG. 2, an absorbent circuit 1 with an absorber 11 and a desorber 12 connected therein. In addition, FIG. 3 also shows, however, a condenser 13 connected downstream of the desorber for supply of a vapor 18. The condenser 13 has a gas line for discharge of gaseous CO2, and a condensate removal line 14 through which a condensate 6 can be supplied to a purifying apparatus 15.

The purifying apparatus 15 can be configured as an activated carbon filter, or else as a distillation plant 17. The purifying apparatus removes the degradation products 7 from the condensate 6. The purifying apparatus 15 is connected again to the desorber via a condensate recycle line 16 for discharge of a purified condensate 6. The suitability of the condensate for purification is particularly good because the concentration of degradation products 7 in the condensate 6 is particularly high. And since the condensate 6 constitutes merely a small substream of the overall absorbent 9 in the absorbent circuit 1, the dimensions of the purifying apparatus can be correspondingly small, which allows cost and energy savings.

An advantage of the invention is that it can be employed equally promisingly in small and in large processing plants, for example a CO2 capture plant. It is also possible to integrate the invention into existing processing plants without any problem. In any case, the invention allows a significant reduction in the level of degradation products emitted by the flue gas, and also in the concentration of degradation products in the absorbent.

1. A process for removal of volatile degradation products from an absorbent circuit of a CO2 separation process, the absorbent circuit comprising an absorption process and a desorption process, comprising:
withdrawing condensate from a condensation process connected downstream of the desorption process, and
purifying the condensate to substantially free it of degradation products, which forms a purified condensate which is recycled back to the absorbent circuit.

2. The process as claimed in claim 1, in which the condensate is purified by distillation to free it of degradation products.

3. The process as claimed in claim 1, in which the condensate is purified to free it of degradation products by an activated carbon wash.

4. The process as claimed in claim 1, in which the absorbent conducted within the absorbent circuit is an aqueous solution of an amine, of an amino acid, or of potash.

5. An apparatus for removal of volatile degradation products from an absorbent in a CO₂ separation apparatus comprising
an absorber and a desorber connected within an absorbent circuit,
a purifying apparatus wherein condensate can be supplied via a condensate removal line of the purifying apparatus to a condenser connected downstream of the desorber, and a condensate purified to free it of degradation products in the purifying apparatus can be recycled via a condensate recycle line back to the absorbent circuit.

6. The apparatus as claimed in claim 5,
wherein the purifying apparatus is a distillation plant in which the degradation products can be removed by distillation from the condensate.

7. The apparatus as claimed in claim 6,
wherein the purifying apparatus comprises an activated carbon filter by which the degradation products from the condensate can be retained.
